(19) United States
(12) Patent Application Publication
(10) Pub. No.: US 2022/0168821 A1
(43) Pub. Date: Jun. 2, 2022

(54) CLAMPING MODULE FOR MACHINE TOOL AND METHOD OF DETERMINING CURVATURE OF GUIDE FACE OF CLAMPING MODULE

(71) Applicant: SAMCHULLY MACHINERY CO., LTD, Incheon (KR)

(72) Inventors: Jae Won SEO, Seoul (KR); Kyung Jin LEE, Incheon (KR)

(73) Assignee: SAMCHULLY MACHINERY CO., LTD, Incheon (KR)

(21) Appl. No.: 17/407,776

(22) Filed: Aug. 20, 2021

(30) Foreign Application Priority Data
Dec. 1, 2020 (KR) 10-2020-0165277

(51) Int. Cl. B23B 31/107

(52) U.S. Cl. CPC B23B 31/1073

(57) ABSTRACT

A clamping module for a machine tool is proposed. The clamping module includes: a body having a mount hole that a pull stud enters; a plunger configured to clamp or unclamp the pull stud by sliding forward or backward radially from a center of the mount hole; a plunger pin protruding from a side of the plunger and configured to freely rotate; and a clamp plunger having a guide groove configured to move the plunger forward and backward by interfering with the plunger pin while moving up and down inside the body, in which the guide groove has a first guide face for moving forward the plunger to a clamping position and a second guide face for moving backward the plunger to an unclamping position; and the first guide face is an arc-shaped curved shape having a uniform radius of curvature.

### CROSS REFERENCE TO RELATED APPLICATION

The present application claims priority to Korean Patent Application No. 10-2020-0165277, filed Dec. 1, 2020, the entire contents of which is incorporated herein for all purposes by this reference.

### BACKGROUND OF THE INVENTION

### Field of the Invention

The present disclosure relates to a clamping module quickly fixing a workpiece at an accurate position on a machine tool, and a method of determining a curvature of a guide face involved with clamping.

### Description of the Related Art

When a workpiece is machined by a machine tool, the position where the workpiece is fixed with respect to the working tool is in direct relation to the machining quality, so it is very important.

Considering the case of replacing workpieces on a machine tool for machining process division or mass production of the same kind of products, it is required to quickly and very accurately clamp workpieces.

To this end, a zero-point clamping system that simultaneously performs setting and clamping has been proposed. A clamping system, which is also called a quick change system, uses several pull studs installed under a palette on which a workpiece is fixed, and clamping modules installed on the table of a machine tool to correspond to the pull studs, respectively. As the pull studs are inserted and nipped in the clamping modules, respectively, clamping and positioning of the palette and a workpiece are simultaneously performed. As the time for setting a workpiece decreases, a tool operation time correspondingly increases, so productivity increases.

In relation to the structure for driving a plunger, etc. of a clamp module, a plunger that radially tightens the circumference of a work has been disclosed in Japanese Patent Application Publication No. 2010-221376. Further, a structure in which a plunger straightly moves over an arc cam groove has been disclosed in Japanese Patent Application Publication No. 1995-214446. Further, a structure in which a pin is guided by a guide groove having a smooth curved surface has been disclosed in Japanese Patent Application Publication No. 2016-80156.

Meanwhile, configurations that perform clamping by converting a vertical motion into a horizontal motion have been disclosed in Korean Patent No. 10-0626250, Korean Patent Application Publication No. 10-2003-0051378, etc.

### SUMMARY OF THE INVENTION

An objective of the present disclosure is to provide a clamping module that tightens and fixes or loosens a pull stud well because there is little possibility of wear in spite of repeated use.

Other detailed objectives of the present disclosure will be understood by specialists or researchers in the field through the following detailed description.

In order to achieve the objectives of the present disclosure, a clamping module for a machine tool according to an embodiment includes: a body having a mount hole that a pull stud enters; a plunger configured to clamp or unclamp the pull stud by sliding forward or backward radially from a center of the mount hole; a plunger pin protruding from a side of the plunger and configured to freely rotate; and a clamp plunger having a guide groove configured to move the plunger forward and backward by interfering with the plunger pin while moving up and down inside the body, in which the guide groove has a first guide face for moving forward the plunger to a clamping position and a second guide face for moving backward the plunger to an unclamping position; and the first guide face is an arc-shaped curved shape having a uniform radius of curvature.

A slope of a tangent line at a contact point on the curve with the plunger pin may gradually increase as the plunger is moved from an unclamping position to a clamping position.

The radius of curvature may be a radius of a circle constructed to satisfy a movement distance similarity of 85% or more to a curve of an available section selected to satisfy a required operation value determined as a horizontal movement distance of the plunger to a vertical movement of the clamp plunger of a cycloid curve according to the diameter of the plunger pin.

A lubricating part may be disposed between a pin hole formed through the side of the plunger and the plunger pin mounted in the pin hole, so the plunger pin may be freely rotated.

A method of determining a radius of curvature of the first guide face of the clamp plunger considers a cycloid curve and an actual operation section of the plunger pin according to mechanical design conditions. In detail, the method includes: constructing a cycloid curve according to a diameter of the plunger and a triangle having a required operation value, which is determined as a horizontal movement distance of the plunger to a vertical movement distance of the clamp plunger, as a hypotenuse; selecting an available section that is a curved section satisfying the required operation value, by moving the cycloid curve in a plane such that two end points of the hypotenuse of the triangle intersects the cycloid curve; and selecting a radius of a circle satisfying a movement distance similarity of 85% or more to the curve selected as the available section of circles all passing both end points of the hypotenuse and any one point on the curve of the available section, as the radius of curvature of the first guide face.

According to an embodiment of the present disclosure, the clamping efficiency by the plunger is increased. It is possible to quickly clamp a pull stud with an intended fastening force, reduce noise or shaking generated when the clamping module is operated, and improve the reliability and expected lifespan of the equipment.

Other effects of the present disclosure will be apparently grasped and understood by specialists or researchers in the field through the following detailed description or a process of implementing the present disclosure.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a schematic perspective view of a clamping module according to an embodiment of the present disclosure;

FIG. 2 is an exploded view showing main parts of the embodiment shown in FIG. 1;

FIG. 3 is a front view of a clamp plunger employed in the embodiment shown in FIG. 1;

FIG. 4A is a cross-sectional view briefly showing a clamping state of the embodiment shown in FIG. 1;

FIG. 4B is a cross-sectional view showing an unclamping state of the embodiment shown in FIG. 1;

FIG. 5 is a view schematically showing the relationship between a plunger pin and a guide face;

FIGS. 6A to 6G are views schematically showing a process of calculating a radius of curvature of a guide face according to an embodiment of the present disclosure; and

FIG. 7 is a view showing the operational relationship between a guide groove and a plunger pin when the calculated radius of curvature is applied.

### DETAILED DESCRIPTION OF THE INVENTION

Hereafter, the configuration, function, and operation of a clamping module for a machine tool according to the present disclosure are described with reference to the accompanying drawings. However, the same reference numerals are given to the same or similar components in all the figures.

In the following description, terms ‘first’, ‘second’, etc. are used for convenience to discriminate components of which the technical meanings are in the same categories. That is, any one component may be certainly referred to as a ‘first component’ or a ‘second component’.

The accompanying drawings show embodiment to which the present disclosure is applied and the spirit of the present disclosure should not be constructed as being limited to the accompanying drawings. If some or all of those shown in the drawings can be construed as not being the forms, shapes, and orders necessarily required to achieve the present disclosure from the viewpoint of specialists in this field.

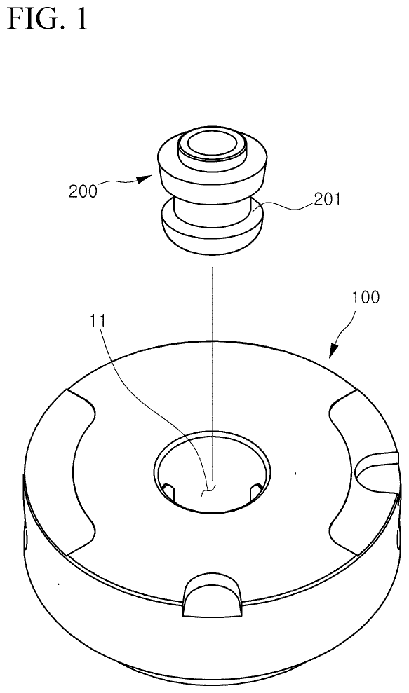

FIG. 1 shows a full stud 200 and a clamping module 100 having a mount hole 11 that the pull stud 200 enters. The pull stud 200 is formed in a substantially conical shape with a circumferential groove 201 on the outer surface in which a plunger of the clamping module 100 is tightened and fixed.

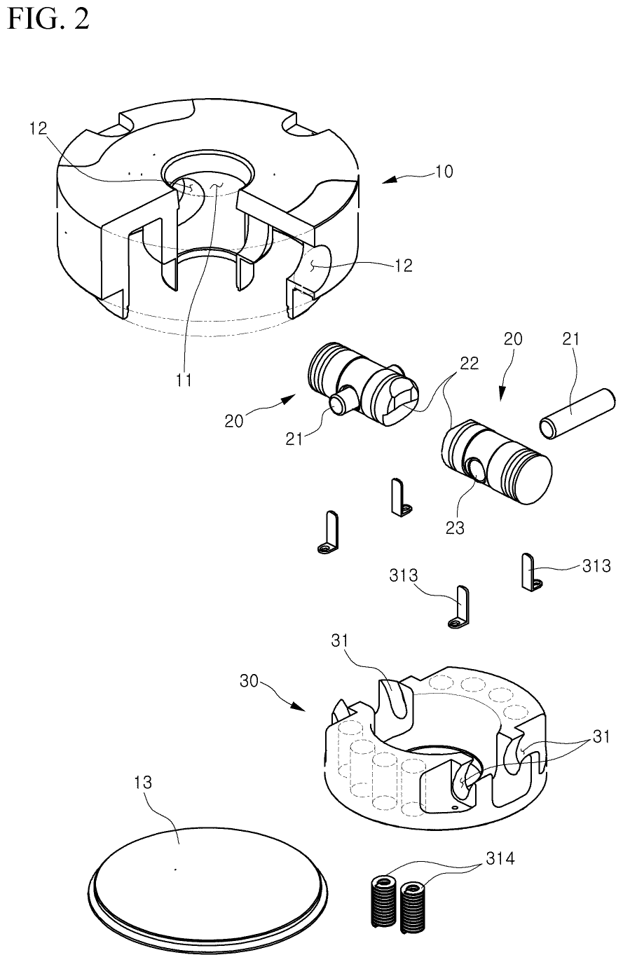

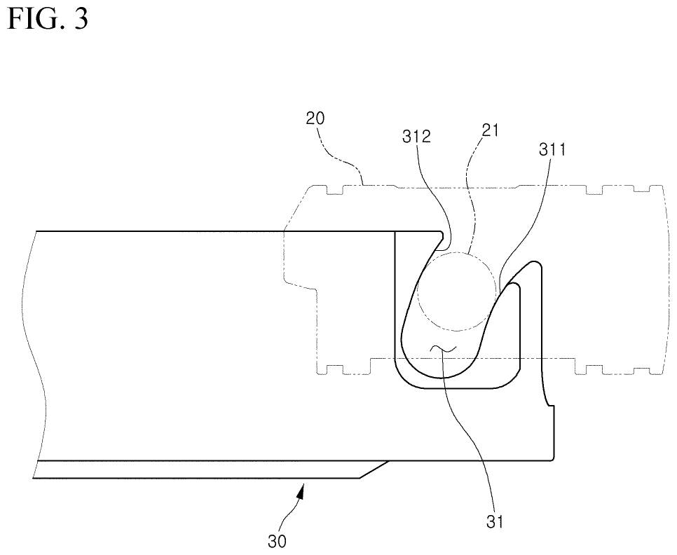

FIGS. 2 to 3 relate a clamping module according to an embodiment of the present disclosure.

The clamping module 100 according to an embodiment includes a body 10, a plunger 20, a plunger pin 21, and a clamp plunger 30.

The mount hole 11 that is open upward and a sliding hole 20 connected to the inner surface of the mount hole and guiding horizontal movement of the plunger 20 are formed in the center of the body 10.

The sliding hole 12 is formed through the body radially from the plane center of the mount hole 11, so the plunger 20 is moved on a plane toward the center of the mount hole 11 through the sliding hole.

In the shown embodiment, the sliding hole 12 and the plunger 20 each are provided in a pair facing each other with the center hole therebetween. Though not shown, three or more sliding holes and plungers may be arranged with regular intervals around the center of the mount hole.

A coupling portion 22 that enters the circumferential groove 201 of the pull stud 200 coming in the mount hole 11 is formed at the front of the plunger 20.

The contact surface of the coupling portion with the inner surface of the circumferential groove may be inclined so that the pull stud is aligned with the center of the mount hole when the plunger is pressed toward the pull stud with the circumferential groove and the coupling portion are in contact.

The plunger pin 21 is combined with the plunger 20 such that both ends protrude from the left and right sides of the plunger 20, respectively. The longitudinal direction of the plunger pin 21 is perpendicular to the front-rear movement direction of the plunger 20.

A lubricating part 23 such as a roller bearing or a ball bearing is disposed between the pin hole of the plunger 20 and the plunger pin 21, so the plunger pin 21 can be freely rotated.

The clamp plunger 30 is disposed inside the body 10 to be movable up and down. Guide grooves 31 that enable the plunger 20 to be moved forward and backward while interfering with the plunger pin 21 are formed at the clamp plunger 30. When the clamp plunger 30 is moved up or down with the inner surfaces of the guide grooves 31 in contact with the plunger pins 21, the plunger pins 21 and the plungers 20 are moved forward or backward with respect to the mount hole 11, thereby clamping or unclamping the pull stud 200.

The plunger pin 21 that has come in the guide groove 31 is positioned between a pair of pin plates 313 vertically disposed in the clamp plunger 30, so the plunger pin 21 is not unexpectedly separated.

A rear cover 13 is coupled to the bottom of the body 10 after the clamp plunger 30 is mounted.

Springs 314 are disposed between the clamp plunger 30 and the rear cover 13. The restoring force of the springs 314 acts always to move up the clamp plunger 30. Accordingly, unless there is a specific external force that moves down the clamp plunger 30 such as high-pressure oil, the clamp plunger 30 keeps lifted in the internal space of the body.

FIGS. 3 to 5 relate to clamping or unclamping by the clamping module.

Referring to FIG. 3, the guide groove 31 is formed at a pair of parallel blocks vertically disposed on the left and right of the clamp plunger 30. The plunger pin 31 is inserted along the inner surfaces of the guide grooves 31.

The guide groove 31 has a first guide face 311 and a second guide face 312, which are spaced apart from each other more than the diameter of the plunger 21 pin 21.

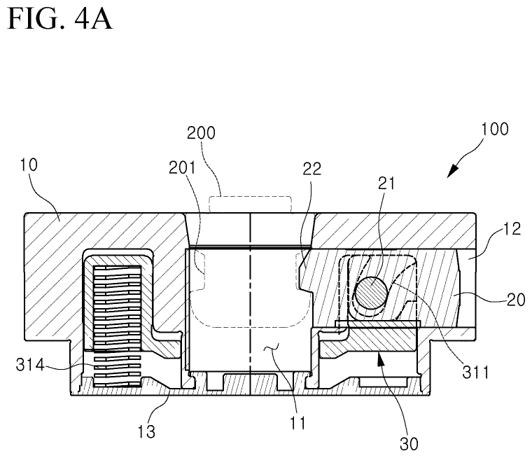

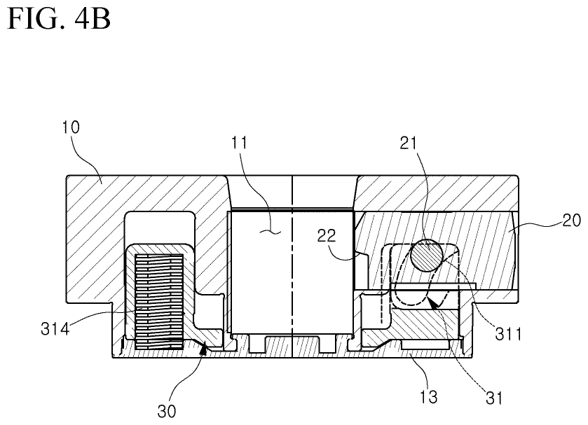

When the clamp plunger 30 is moved up, the plunger pin 21 comes in contact with the first guide face 311 and the plunger 20 is moved forward (left in FIG. 3). Accordingly, the pull stud 20 in the mount hole 11 is tightened and fixed (see FIG. 4A).

When the clamp plunger 30 is moved down, the plunger pin 21 comes away from the first guide face 311 and comes in contact with the second guide face 312. As the clamp plunger keeps being moved down, the plunger 20 is moved backward (right in FIG. 3) while the plunger pin 21 is moved on the second guide face 312. Accordingly, the pull stud fixed by the plunger is released.

FIG. 4A shows a clamping position where a pull stud is fixed, in which the clamp plunger 30 has been moved up, and accordingly, the plunger pin 21 and the plunger 20 have been moved toward the center of the mount hole by the guide grooves 31.

The clamp plunger 30 can be moved up by only the springs. Alternatively, working oil for moving up the clamp plunger together with the springs may be additionally applied as external force.

FIG. 4B shows an unclamping position, in which the clamp plunger 30 moved up has been moved down, and accordingly, the plunger pin 21 and the plunger 20 have been moved backward away from the center of the mount hole by the second guide face 312 of the guide groove.

High-pressure oil or compressed air for moving down the clamp plunger may be supplied from a machine tool. The clamp plunger may be moved down by an electric device such as an electromagnet or a motor.

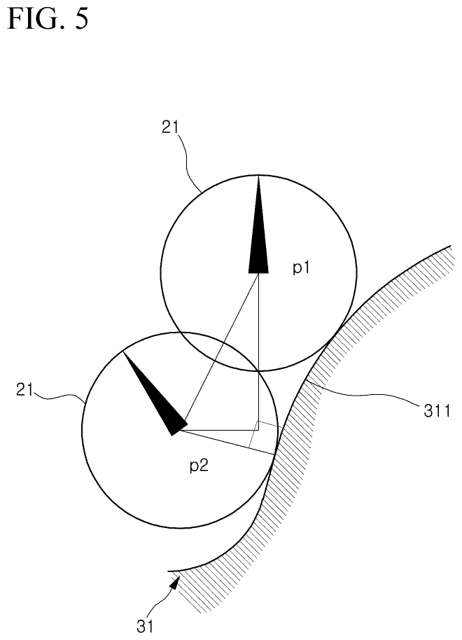

FIG. 5 briefly shows the operational relationship between the first guide face 311 and the plunger pin 21.

Originally, as the clamp plunger 30 is moved up and down, the first guide face 311 is moved up and down and the plunger pin 21 is moved left and right in a horizontal plane. However, as shown in the figure, the movement of the components may be considered as that the plunger pin 21 moves on the first guide face 31 with the first guide face 311 fixed. As the first guide face 311 is moved up, the plunger pin 21 is moved from the position p1 to the position p2 and the plunger 20 is moved forward toward the center of the mount hole.

Since the plunger pin 21 can be freely rotated, the plunger pin 21 rolls on the first guide face 311 while the plunger 20 is moved forward.

The first guide face 311 is an arc-shaped curved surface having a uniform radius of curvature.

Since the first guide face 311, which the plunger pin comes in contact with, is an arc-shaped curved surface having a uniform radius of curvature, the curved surface can be easily and precisely formed. Since the shape of the curved surface is simple, there is no problem of stress concentration even though the clamping module repeatedly used under a high operation pressure, and the plunger pin is pushed well.

In the first guide face 311, the slopes L1 and L2 of the tangent lines at the contact points on the curved surface with the plunger pin 21 gradually increase as the plunger 20 is moved from the unclamping position p1 to the clamping position p2.

The slope L of the tangent line on the first guide face 311 around the unclamping position p1 is relatively small, so the forward-movement distance of the plunger 20 by upward movement of the clamp plunger 30 is longer than the forward-movement distance of the plunger at the clamping position to be described below. That is, the plunger 20 is moved fast forward at the early stage at which the plunger 20 is moved forward from the unclamping position p1 to the clamping position p2.

As the plunger keeps moving to the clamping position p2, the slope L1 of the tangent line at the contact point between the plunger pin 21 and the first guide face 311 gradually increases. This means that the plunger 20 moves a short distance forward in comparison to upward movement of the clamp plunger 30, which remarkably increases the fastening force by the coupling portion 22.

In short, as the clamp plunger 30 is moved up, the plunger 20 at the unclamping position p2 is moved fast forward at the early stage, and consequently, quickly approaches the pull stud. Further, after the coupling portion enters the circumferential groove of the pull stud, the forward movement speed is decreased, but the fastening force is increased, whereby the pull stud can be strongly tightened and fixed.

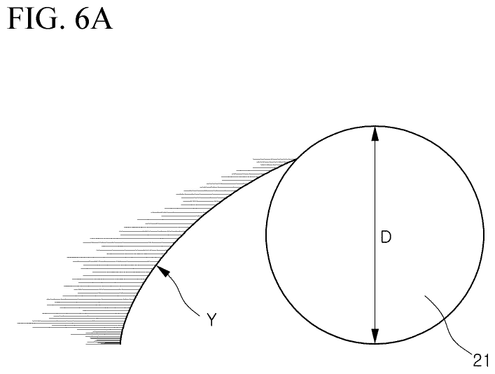

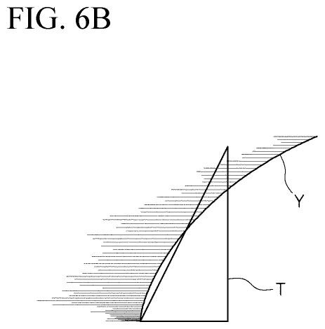

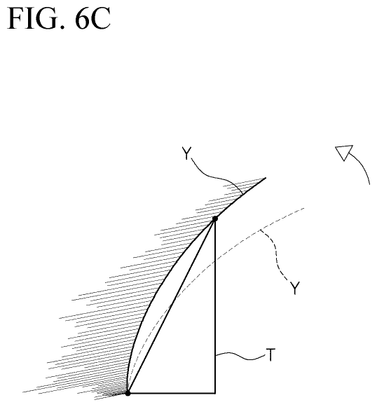

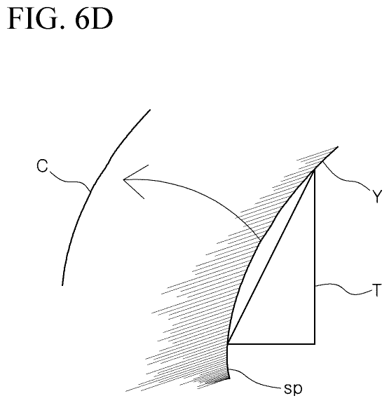

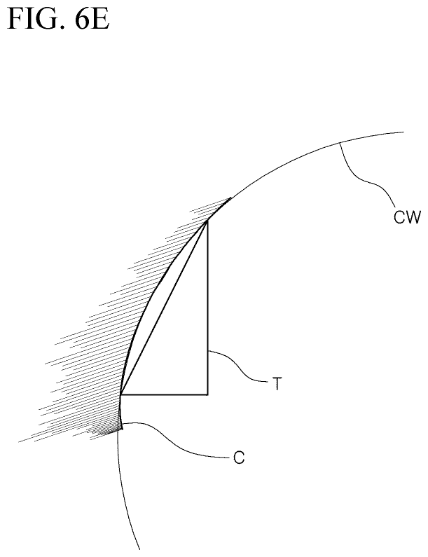

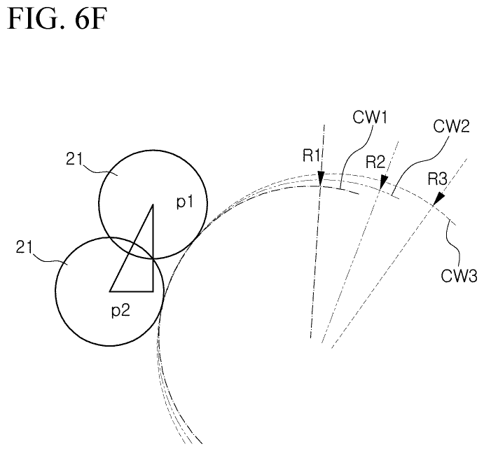

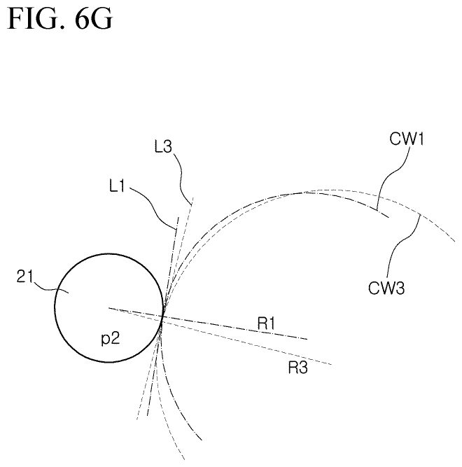

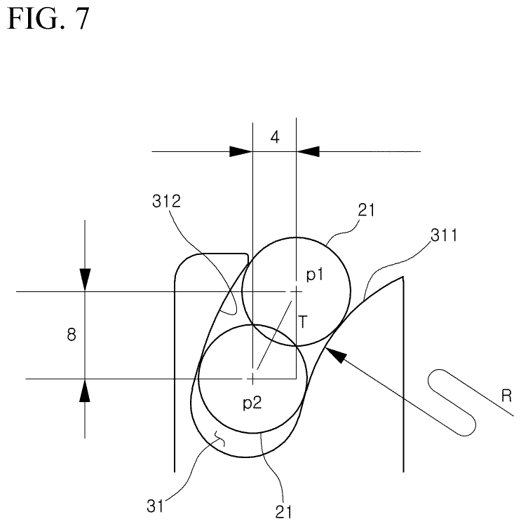

FIGS. 6A to 7 are views relating to the radius of curvature of a guide face.

The radius of curvature of the guide faces 311 and 312 is set such that the guide faces 311 and 312 are as close as possible to a cycloid curve so that the plunger pin 21 smoothly rolls on the guide faces 311 and 312 when the clamp plunger 30 is moved up and down.

Further, the radius of curvature should be set in consideration of the required operation value that is the ratio of the horizontal movement distance of the plunger 20 to the vertical movement distance of the clamp plunger 30 so that the plunger 20 can move a desired distance forward and backward while the plunger pin 21 rolls on the guide face 311.

The required operation value is the ratio of the movement distance of the clamp plunger 30 and the movement distance of the plunger 20 depending on the clamping position p2 and the unclamping position p1. The required operation value depends on the fundamental design of the clamping module and may be varied in accordance with various limit factors such as required strength according to the shape, material, structure, or the like of the body, clamp plunger, plunger, plunger pin, etc., and an operation condition such as the pressure of the provided working oil.

For example, when the clamping module is designed in a certain shape, a condition in which when the clump plunger vertically moves 8 mm, the plunger horizontally moves 4 mm may be required (see FIG. 7). The ratio of the movement distances of the clamp plunger and the plunger can be the required operation value of the clamping module.

FIGS. 6A to 6G relate to setting the radius of curvature of a guide curve.

FIG. 6A shows a cycloid curve Y according to the diameter D of the plunger pin 21 that is used.

FIG. 6B shows the cycloid curve Y and a required operation value overlapping each other. The required operation value is shown by a right-angle triangle showing a horizontal movement distance and a vertical movement distance. Both end points of the hypotenuse of the triangle relate to the clamping position and the unclamping position.

Since the cycloid curve Y itself constructed in a plane coordinate system composed of a horizontal line and a vertical line perpendicular to each other cannot satisfy the required operation value T, the cycloid curve Y is rotated or moved up, down, left, and right in accordance with the required operation value T. Such movement of a cycloid curve in a plane may be achieved by a method of putting a transparent film on which a cycloid curve is constructed on a paper on which a triangle is constructed, and then moving the film here and there or rotating the film. Alternatively, it is possible to obtain the aid of a computer-operable program.

The cycloid curve Y is fitted to the required operation value by being rotated clockwise in FIG. 6C. The cycloid curve Y is schematically fitted to the required operation value T by being rotated and moved in a plane in FIG. 6D.

In FIG. 6D, the cycloid curve Y is in contact with the right-angle triangle, which is a required operation value, from a middle portion spaced apart from the start point sp of the cycloid curve Y.

The start point sp of the cycloid curve is theoretically close to verticality, and the slope of the tangent line at the start point becomes even a negative slope beyond verticality as the cycloid curve Y is rotated to be fitted to the required operation value. At the point where the slope of the tangent line is close to verticality or is negative, the guide face cannot horizontally move the plunger even though the clamping plunger is moved up, so this case cannot be used. Accordingly, the start point sp of the cycloid curve needs to be excluded.

A partial section of the cycloid curve satisfying the required operation value at a position spaced a predetermined distance from the start point of the cycloid curve, as shown in FIG. 6D, is set as an available section C that is used to calculate a radius of curvature. That is, the start point and the end point of the available section C depend on two apexes of the triangle T according to the required operation value, and a curve connecting these two points is a curve according to the cycloid curve Y.

FIG. 6E shows a circle CW constructed similar to the available section C. The circle CW can be obtained by constructing a circle that passes apexes of a right-angle triangle T according to the required operation value, that is, both end points of the hypotenuse of the triangle and passes any one point on the available section C.

FIG. 6F shows several circles CW1, CW2, and CW3 that are close to the available section C of cycloid curves and satisfy a required operation value. The radii R1, R2, and R3 of these circles are different from each other in accordance with the similarity to the curve of the available section C.

FIG. 6G shows two circles CW1 and CW3 to which the plunger pin is tangent at the clamping position. However, the difference of curvatures is exaggerated so that the two circles can be easily discriminated.

When the circle CW1 having a smaller radius and indicated by a dash-dotted line is selected, comparing the slope L1 at the contact point of the plunger pin 21 and the guide face at the clamping position with the slope L3 at the contact point on the circle CW3 having a larger diameter and indicated by a dotted line, the slope of the tangent line indicated by a dotted line is more gentle (slope L3<slope L1).

This means that when the larger-diameter circle CW3 is selected as the curved surface of the first guide face 311, the plunger pin 21 can be stably moved forward and backward when the clamping plunger is moved up and down. Even if there is an operation error due to a gap formed by an assembly error or wear of the clamping module, foreign substances stuck between the outer surface of the plunger pin and the guide race, etc., reliability in forward and backward movement of the plunger pin is improved.

In order to compensate this interaction of the clamping plunger and the plunger pin, it is advantageous to calculate the radius of curvature of a guide face on the basis of a larger-diameter circle, but the following additional limitations may be given to improve efficiency according to rolling of the plunger pin 21.

Since as the guide face is similar to the curve of the available section C, a slip of the plunger pin is minimized and plunger pin smoothly rolls, the radius of a circle constructed to satisfy movement distance similarity of 85% or more to the curve of the available section is selected as the radius of curvature.

The movement distance similarity is the percentage of the distance that a plunger rolls on the curve of an available section (cycloid curve) and the distance that a plunger pin rolls on the constructed circle. That is, it is the ratio of the distance that a plunger rolls on an arc selected in a height section the same as an available section and the distance that the plunger pin rolls on the available section.

For example, when the length of an available section is 10.241 mm and the length of an arc of a corresponding section of a circle is 9.131 mm, the movement distance similarity of 89.161% is calculated from the ratio of the lengths.

A circle satisfying a movement distance similarity of 85% or more is selected from several circles satisfying the required operation value and similar to the available section and the radius of the circle is selected as the radius of curvature of the first guide race.

When the movement distance similarity is less than 85%, the plunger pin slips more without rolling well on the guide face, which causes problems such as heat generation, an increase of wear, and noise.

In the final step in which the inclined surfaces of the coupling portion 22 and the inner side of the pull stud 200 come in contact with each other and the pull stud 200 is aligned during clamping (see FIG. 4A), the surface pressure between the plunger pin 21 and the first guide face 311 which moves forward the plunger 20 gradually increases. In this process, when the movement distance similarity is less than 85%, the plunger pin slides on the guide face and the corresponding portion is worn, so a problem that heat generation, noise, and vibration are considerably increased. As wear progresses, the pull stud that has to be precisely aligned is not completely aligned. In particular, when the clamping module is operated in a pneumatic type in which direct lubrication such as supplying a lubricant is difficult, these problems are more increased, so it is very important to improve the rolling ability without sliding of the plunger pin.

The first guide face 311 to which a selected radius of curvature is applied and the plunger pin 21 rolling on the first guide face 311 are shown in FIG. 7.

The radius of curveted calculated under the conditions described above is applied to the radius R of curvature of a curved surface in a section in which the plunger pin 21 rolls in contact with the first guide face 311 from the unclamping position p1 to the clamping position p2.

As the position is changed from the unclamping position p1 to the clamping position p2, while the plunger pin 21 rolls on the first guide face 311, the plunger 20 moves fast forward at the early stage and gradually increases the fastening force while approaching the final clamping position, whereby the operation efficiency of the plunger is improved.

Since the plunger pin 21 smoothly rolls on a single curved surface, noise and shaking due to mechanical friction are reduced in clamping or unclamping. Further, the possibility of damage to the pin or the guide face due to stress concentration decreases, and accordingly, the expected lifespan of the equipment is increased.

What is claimed is:

1. A clamping module for a machine tool, comprising:
a body having a mount hole that a pull stud enters;
a plunger configured to clamp or unclamp the pull stud by sliding forward or backward radially from a center of the mount hole;
a plunger pin protruding from a side of the plunger and configured to freely rotate; and
a clamp plunger having a guide groove configured to move the plunger forward and backward by interfering with the plunger pin while moving up and down inside the body,
wherein the guide groove has a first guide face for moving forward the plunger to a clamping position and a second guide face for moving backward the plunger to an unclamping position;
the first guide face is an arc-shaped curved shape having a uniform radius of curvature; and
the radius of curvature is a radius of a circle constructed to satisfy a movement distance similarity of 85% or more to a curve of an available section selected to satisfy a required operation value determined as a horizontal movement distance of the plunger to a vertical movement of the clamp plunger of a cycloid curve according to the diameter of the plunger pin.

2. The clamping module of claim 1, wherein a slope of a tangent line at a contact point on the curve with the plunger pin gradually increases as the plunger is moved from an unclamping position to a clamping position.

3. The clamping module of claim 1, wherein a lubricating part is disposed between a pin hole formed through the side of the plunger and the plunger pin mounted in the pin hole, so the plunger pin can be freely rotated.

4. A method of determining a curvature of a guide face of a clamping module, which determines a uniform radius of curvature of a first guide face of a clamping module
that includes: a body having a mount hole that a pull stud enters; a plunger configured to clamp or unclamp the pull stud by sliding forward or backward radially from a center of the mount hole; a plunger pin protruding from a side of the plunger and configured to freely rotate; and a clamp a guide configured to move up and down inside the body and having a guide groove having the first guide face for moving forward the plunger to a clamping position by interfering with the plunger pin and a second guide face for moving backward the plunger to an unclamping position,
the method comprising:
constructing a cycloid curve according to a diameter of the plunger and a triangle having a required operation value, which is determined as a horizontal movement distance of the plunger to a vertical movement distance of the clamp plunger, as a hypotenuse;
selecting an available section that is a curved section satisfying the required operation value, by moving the cycloid curve in a plane such that two end points of the hypotenuse of the triangle intersects the cycloid curve; and
selecting a radius of a circle satisfying a movement distance similarity of 85% or more to the curve selected as the available section of circles all passing both end points of the hypotenuse and any one point on the curve of the available section, as the radius of curvature of the first guide face.
